(19) United States
(12) Patent Application Publication
(10) Pub. No.: US 2015/0164265 A1
(43) Pub. Date: Jun. 18, 2015

(54) Coffee machine which can compatible with all types of coffee cups

(71) Applicant: Jiangxi Misheng Technology Co., Ltd., Jingdezhen City (CN)

(72) Inventor: Jieshun Cheng, Shangrao City (CN)

(73) Assignee: Jiangxi Misheng Technology Co., Ltd., Jingdezhen City (CN)

(21) Appl. No.: 14/109,884

(22) Filed: Dec. 17, 2013

(51) Int. Cl. A47J 31/44

(52) U.S. Cl. CPC A47J 31/4403

(57) ABSTRACT

A coffee machine is described that is compatible with all types of coffee cups and includes a coffee machine body that is equipped a funnel, where the bottom of the funnel includes a leak stoppage valve. The exterior of the coffee machine body includes a control button, an electromagnetic valve opening device and a rotating bracket opening device. Such a coffee machine allows coffee cups of different heights to open the funnel valve automatically.

### FIELD OF THE INVENTION

An aspect of the present invention relates to a coffee machine, more particularly, the described technology relates to a coffee machine which can be compatible with all types of coffee cups.

### DESCRIPTION OF THE RELATED ART

The present coffee machines are mainly classified into the following types: the steam type, the drip type and the capsule type, etc., which is equipped with the valve function for preventing to leakage liquid. And the method to open the funnel valve by mechanical operation, that is you should put the coffee cups to touch the funnel valve, to make the funnel, valve opened. The limitations of the known coffee machine, it required that the coffee cups which can be match with the coffee machine. If the coffee cups lost or broke, the coffee machine will be unavailable, unless to re-purchase the coffee cups which is matched with the coffee machine. So it will be a more and more necessary to have a more convenient way to open the funnel valve and also can be compatible with, all kinds of the coffee cups.

### SUMMARY OF THE INVENTION

This present invention proposes to provide a coffee machine which can be compatible with all types of the coffee cups, which can overcome the problem of the known cups which must use the match coffee cups.

To meet these objects, the present invention provides a coffee machine which can be compatible with all types of the coffee cups, comprising: a coffee machine body, which is equipped a funnel, and the bottom of the funnel is a leak stoppage valve; there is a control button which is outside of the coffee machine body, and there is an electromagnetic valve opening device and the rotating bracket opening device;

The electromagnetic valve opening device, includes the lever, the silicon steel sheet and the electromagnet.

The side of the lever is connected with the leak stoppage valve, and the other side is fixed with the silicon steel sheet; there is a fixing hole in the middle of the lever, and the lever is fixed on the coffee machine body by the fixing hole; the electromagnet is fixed inside of the coffee machine body, where is just below the silicon steel sheet, and connected with the control button by the wires.

Further, the rotating bracket opening device, includes a button device, a button link, a bracket, an axis of rotation, and a rotary spring;

There is a bayonet on the side of the bracket, the side of the button link is connected with the button device, and the other side is clamped, on the bayonet of the bracket, the middle of the button link is fixed a fixing hole, and the button link is also fixed on the coffee machine body by the fixing hole. The connection of the coffee machine body and the bracket is active connection by the bracket axle. The rotary axis is fixed on the bracket, and the rotary spring is fixed on it.

Further, there is a silicone gasket is fixed between the leak stoppage valve and the inner wall of the funnel.

Further, there is spring between the leak stoppage valve and the outer wall of the funnel.

Further, the button device, includes of button, button spring and button box, the button spring is connected the button, and placed in the button box, which is fixed on the coffee machine body.

In the present invention, there is a electromagnet and a lever are fixed in the coffee machine, and the electromagnet makes the funnel valve opened by the magnetic field and lever principle. After pressing the control button, the magnetic coil is energized to produce electromagnetic force, it will adsorb on the silicon steel which is fixed on the lever, the lever and the silicon steel will be downward rotation around the lever, and the front of the lever pushed the leak stoppage valve moving upward, so it opened the funnel valve, to make the coffee flowing into the coffee cup. Then the valve can be opened automatically.

The bracket is fixed on the coffee machine body, the side of the button link is snapped into the bayonet of the bracket. When the bracket is fixed in the coffee machine body, then pressing the button to compress the rotary spring backwards, and the button link will be rotating around the pivot of the link, which front will be backward, then the button link will be separated from the bracket, and the bracket will be rotated to the horizontal. Then you can put the low coffee cup on the bracket, it will be ok.

The advantage of the present invention is that it can, overcome the problem of that you must use the match coffee cups for the coffee machine, and all types of coffee cups can open the funnel valve automatically, whatever the cups are high or low

### BRIEF DESCRIPTION OF THE DRAWINGS

FIG. 1 is the schematic view of the coffee machine which can be compatible with all types of coffee cups, which is not in use;

FIG. 2 is the schematic view of the coffee machine which can be compatible with all types of coffee cups, which is in use;

FIG. 3 is the schematic view of the control button of the coffee machine which can be compatible with all types of coffee cups;

FIG. 4 is the schematic view of the bracket of the coffee machine which can be compatible with all types of coffee cups.

Namely, 1—coffee machine body; 2—funnel; 3—leak stoppage valve; 4—control button; 5—electromagnetic valve opening device; 6—rotating bracket opening device; 7—silicone gasket; 8—spring; 51—lever; 52—silicon steel sheet; 53—electromagnet; 61—button device; 62—button link; 63—bracket; 64—axis of rotation; 65—rotary spring; 510—fixing hole; 610—button; 611—button spring; 612—button box; 620—fixing hole; 630—bayonet; 631—bracket axle.

### DETAILED DESCRIPTION OF THE DRAWINGS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In order to clarify the present invention, the elements extrinsic to the description are omitted from the details of this description, and like reference numerals refer to like elements throughout the specification. In several exemplary embodiments, constituent elements having the same configuration are representatively described in a first exemplary embodiment by using the same reference numeral and only constituent elements other than the constituent elements described in the first exemplary embodiment will be described in other embodiments.

### The Exemplary Embodiment

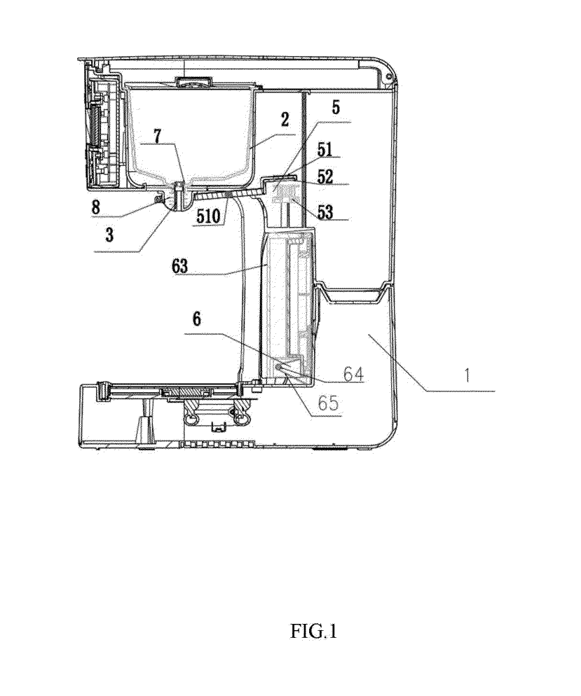

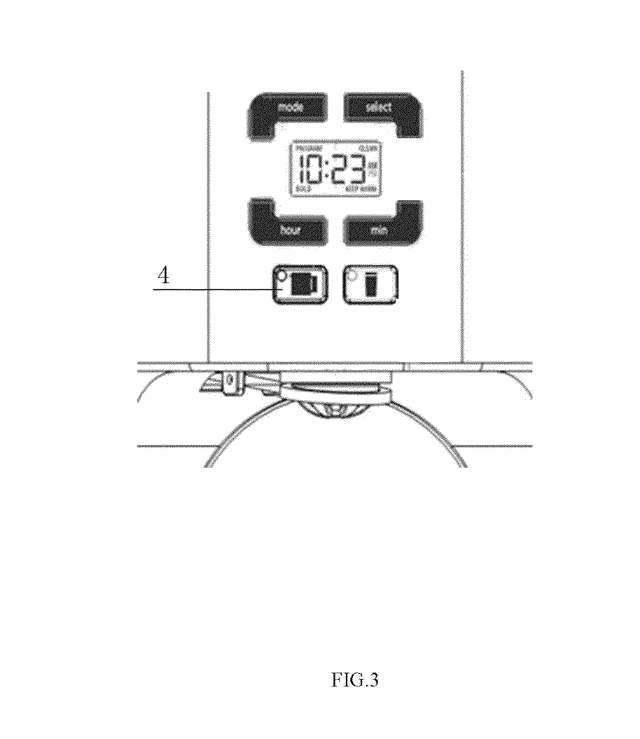

With reference to the accompanying drawings, FIG. 1 is a coffee machine which can be compatible with all types of the coffee cups, comprising: a coffee machine body 1, which is equipped a funnel 2, and the bottom of the funnel 2 is a leak stoppage valve 3. There is a silicone gasket 7 is fixed between the leak stoppage valve 3 and the inner wall of the funnel 2 There is spring 8 between the leak stoppage valve 3 and the outer wall of the funnel 2 FIG. 3 is a control button 4 which is outside of the coffee machine body 1, and there is an electromagnetic valve opening device 5 and the rotating bracket opening device 6. The electromagnetic valve opening device 5, includes the lever 51, the silicon steel sheet 52 and the electromagnet 53. The side of the lever 51 is connected with the leak stoppage valve 3, and the other side is fixed with the silicon steel sheet 53; there is a fixing hole 510 in the middle of the lever 51; and the lever 51 is fixed on the coffee machine body 1 by the fixing hole 510; the electromagnet 53 is fixed inside of the coffee machine body 1, where is just below the silicon steel sheet 52, and connected with the control button 4 by the wires.

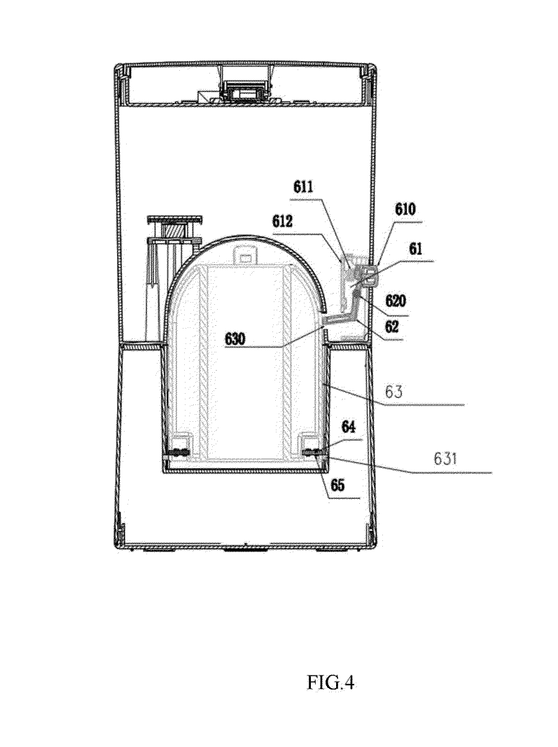

FIG. 4 is the rotating bracket opening device 6, includes a button device 61, a button link 62, a bracket 63, an axis of rotation 64, and a rotary spring 65; the button device 61, includes of button 610, button spring 611 and button box 612, the button spring 611 is connected the button 610, and placed in the button box 612, which is fixed on the coffee machine body 1. There is a bayonet 630 on the side of the bracket 63, the side of the button link 62 is connected with the button device 61, and the other side is clamped on the bayonet 630 of the bracket 63, the middle of the button link 62 is fixed a fixing hole 620, and the button link 62 is also fixed on the coffee machine body 1 by the fixing hole 620. The connection of the coffee machine body 1 and the bracket 63 is active connection by the bracket axle 631. The rotary axis 64 is fixed on the bracket 63, and the rotary spring 65 is fixed on it.

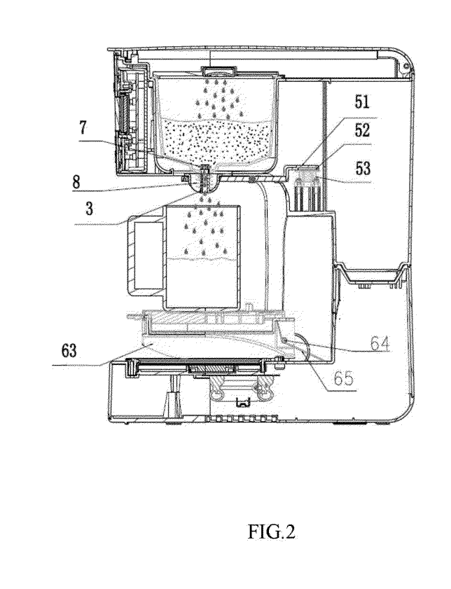

As the FIG. 1 shows, when the coffee machine is not in use, the spring 8 will exert a downward force to the leak stoppage valve 3, it makes the leak stoppage valve 3 to move down, and be closed with the funnel 2 by the silicone gasket 7, then the leak stoppage valve 3 make the funnel 2 be in seal status. As the FIG. 2 shows, when you use the coffee cup which is matched with the coffee machine, just need press the control button 4 which is showing as FIG. 3, then the electromagnet 53 is energized to produce the magnetic field, it will adsorb on the silicon steel 52 to move down. The leak stoppage valve 3 is connected with the lever 51, and the silicon steel 52 is fixed on the other side of the lever 51 According to the lever principle, the silicon steel 52 is moved down by the magnetic field, then the leak stoppage valve 3 will be moved up and opened, so that the coffee can drip into the coffee cup.

If you use the low cups, you just need press the button 610 of the rotating bracket opening device 6, in order to prevent the coffee splash. The button 610 makes the button link 62 and the button spring 611 moving backward, According to the lever principle, the other side of the button link 62 will be separated from the bayonet 630 of the bracket 63, then the bracket 63 will be active connecting with the coffee machine body 1 by the bracket axle 631. The rotary axis 64 is fixed on the bracket 63, and the rotary spring 65 is fixed on it. Because of the force of the rotary spring 65, the bracket 63 will be placed on the machine body after the button link 62 is leaving from the bayonet 630. Then you can put the low coffee cup on the bracket 63, it can raise the height, so that it can shorten the distance between the coffee cup and the funnel 2 to prevent the coffee splash.

Although a few exemplary embodiments of the present general inventive concept have been illustrated and described, it would be appreciated by those skilled in the art that changes may be made in these exemplary embodiments without departing from the principles and spirit of the general inventive concept, the scope of which is defined in the claims and their equivalents.

What is claimed is:

1. A method of a coffee machine which can be compatible with all types of the coffee cups, comprising: a coffee machine body (1), which is equipped a funnel (2), and the bottom of the funnel (2) is a leak stoppage valve (3), there is a control button (4) which is outside of the coffee machine body (1), there is an electromagnetic valve opening device (5) and the rotating bracket opening device (6); The electromagnetic valve opening device (5), includes the lever (51), the silicon steel sheet (52) and the electromagnet (53); The side of the lever (51) is connected with the leak stoppage valve (3), and the other side is fixed with the silicon steel sheet (53), there is a fixing hole (510) in the middle of the lever (51); and the lever (51) is fixed on the coffee machine body (1) by the fixing hole (510); the electromagnet (53) is fixed inside of the coffee machine body (1), where is just below the silicon steel sheet (52), and connected with the control button (4) by the wires.

2. The method according to claim 1, wherein the rotating bracket opening device (6) includes a button device (61), a button link (62), a bracket (63), an axis of rotation (64), and a rotary spring (65); There is a bayonet (630) on the side of the bracket 63, the side of the button link (62) is connected with the button device (61), and the other side is clamped on the bayonet (630) of the bracket (63), the middle of the button link (62) is fixed a fixing hole (620), and the button link (62) is also fixed on the coffee machine body (1) by the fixing hole (620); The connection of the coffee machine body (1) and the bracket (63) is active connection by the bracket axle (631); The rotary axis (64) is fixed on the bracket (63) and the rotary spring (65) is fixed on it.

3. The method according to claim 1, wherein there is a silicone gasket (7) is fixed between the leak stoppage valve (3) and the inner wall of the funnel (2).

4. The method according to claim 1, wherein there is spring (8) between the leak stoppage valve (3) and the outer wall of the funnel (2).

5. The method according to claim 1, wherein the button device (61), includes of button (610), button spring (611) and button box (612), the button spring (611) is connected the button (610), and placed in the button box (612), which is fixed on the coffee machine body (1).
